(19) United States
(12) Patent Application Publication
(10) Pub. No.: US 2025/0172798 A1
(43) Pub. Date: May 29, 2025

(54) MAGNETIC ACTUATION REFLECTIVE DEVICE, AND ASSOCIATED METHOD

(71) Applicant: COMMISSARIAT A L'ENERGIE ATOMIQUE ET AUX ENERGIES ALTERNATIVES, Paris (FR)

(72) Inventors: Bertrand DELAET, Grenoble Cedex 09 (FR); Laurent MOLLARD, Grenoble Cedex 09 (FR); Christel DIEPPEDALE, Grenoble Cedex 09 (FR); Romain LIECHTI, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/958,034

(22) Filed: Nov. 25, 2024

(30) Foreign Application Priority Data
Nov. 28, 2023 (FR) 2313204

(51) Int. Cl. G02B 26/08

(52) U.S. Cl. CPC G02B 26/085

(57) ABSTRACT

A Magnetic actuation reflective device includes a substrate, a mirror configured so as to be pivoted about at least one axis of rotation, and an actuator module comprising at least one magnet and at least one electric line configured to be passed through by an electric current, the actuator module being configured to rotate the mirror by a motor force. The at least one magnet includes a stack of at least one bilayer having a first sublayer based on an antiferromagnetic material and a second sublayer based on a ferromagnetic material. In a method for manufacturing the reflective device, the at least one magnet is formed by a deposition of the stack on the substrate.

### TECHNICAL FIELD

The present invention relates to the field of reflective devices intended to reflect an incident light beam to a target. It has a particularly advantageous application in the field of MEMS (electromechanical microsystems) micromirrors, in particular for LIDAR (light detection and ranging) and imaging applications, for example in pico projectors.

### PRIOR ART

Reflective devices are used in numerous applications in which it is sought to reflect an incident light beam to a given target.

For this, an incident light beam is emitted by a source to the reflective device having a mirror. The mirror has a front face disposed so as to receive the incident light beam. The mirror is oriented with the source so as to form a beam reflected in the direction of the target.

For example, MEMS micromirrors are commonly used for LIDAR or projecting applications. Micromirrors can, for this, comprise an actuator module configured to make the micromirror pivot about at least one axis of rotation. The actuation of the micromirrors can be electrostatic, magnetic or piezoelectric.

The magnetic actuation of the micromirrors is the most widespread. It has, in particular, the advantage of being low frequency linear and has a wide low voltage deflection.

Reflective devices comprising a magnetic actuation module are conventionally manufactured by the heterogeneous assembly of a permanent bulk magnet to a micromirror mechanically coupled to a coil. In these solutions, the bulk magnet is therefore applied to the substrate, for example, by bonding. The integration of such a magnet to the reflective device, requires additional manufacturing steps which could be complex and expensive. In addition, its large volume encumbers the device and increases the energy consumption necessary to actuate the micromirror.

An aim of the present invention is therefore to propose an improved magnetic actuation reflective device solution. An aim of the present invention can, in particular, be to provide a magnetic actuation reflective device, of simplified manufacture. An aim of the present invention can, in particular, be to provide a magnetic actuation reflective device of improved compactness.

Other aims, features and advantages of the present invention will appear upon examining the description below and the accompanying drawings. It is understood that other advantages can be incorporated.

### SUMMARY

To achieve this aim, according to an embodiment, a reflective device intended to reflect an incident light beam is provided, comprising:
a substrate comprising a first part, and a second part which is mobile relative to the first part about at least one axis of rotation,
a mirror disposed securely on the second part of the substrate, the mirror being configured so as to be pivoted about the at least one axis of rotation and so as to receive the incident light beam to form a reflected beam,
an actuator module comprising at least one magnet and at least one electric line configured to be passed through by an electric current (i), the at least one electric line being based on an electrically conductive material, the actuator module being configured to rotate the second part of the substrate and of the mirror by a motor force generated by an interaction between the at least one magnet and the electric current passing through the at least one electric line,
   one from among the at least one magnet and the at least one electric line being disposed on the first part of the substrate, the other from among the at least one magnet and the at least one electric line being disposed on the second part of the substrate, and the at least one magnet comprising a stack of at least one bilayer comprising a first sublayer based on an antiferromagnetic material and a second sublayer based on a ferromagnetic material, the stack being magnetised along at least one magnetisation direction.

The movement of the mirror is thus actuated by the Laplace force generated between the electric line, also called coil, and the magnet. The magnet comprising a stack of sublayers based on alternate ferromagnetic and antiferromagnetic materials, it can be deposited by microelectronic deposition techniques, instead of needing to be added by heterogeneous assembly. As detailed in reference to the method, the homogeneous integration of these different bricks enables the simplification and the reduction of costs of manufacturing the reflective device. Additional heterogeneous assembly steps can be avoided, which are complex and expensive. The performance of the device can further be improved by this homogeneous integration, by limiting the risk of defects of the magnet or more generally, of the device induced by the heterogenous integration. The actuation of the mirror is therefore made reliable. Furthermore, the magnet can thus have dimensions, and in particular, a thickness, reduced with respect to current solutions. This thickness can typically be micronic. The compactness of the device is therefore improved.

A second aspect of the invention relates to a method for manufacturing a reflective device, the method comprising:
a provision of a substrate,
a formation of the actuator module on the upper face of the substrate, the formation comprising:
   a deposition on the upper face of the substrate of a stack of at least one bilayer comprising a first sublayer based on an antiferromagnetic material and a second sublayer based on a ferromagnetic material, superposed to the first sublayer,
   a heat treatment of the deposited stack under application of a magnetic field, so as to magnetise the stack along at least one magnetisation direction,
   a deposition of an electrically conductive material on the upper face of the substrate, so as to form the at least one electric line,
a deposition of a mirror on the upper face of the substrate,
at least one etching of the substrate, so as to form a first part and a second part which is mobile relative to the first part about at least one axis of rotation, the depositions and the etching being configured together, such that the mirror is deposited on the second part of the substrate, one from among the at least one magnet and the at least one electric line is disposed on the first part of the substrate, the other from among the at least one magnet and the at least one electric line is disposed on the second part of the substrate.

The base bricks of a magnetic actuation reflective device are thus formed on the substrate by microelectronic deposition techniques, instead of being added heterogeneously: the electric line, the mirror, and the magnet formed by deposition on the substrate. This monolithic integration is collective of these different bricks, enables the simplification of the manufacture of the reflective device, by avoiding additional heterogeneous assembly steps which can be complex and expensive. The manufacturing costs are thus limited. The monolithic integration also makes it possible to significantly reduce the distance separating the magnet from the electric line. This significant reduction of the distance between the magnet and the electric line would prove to be complex in a manufacture of the actuator module by individual transfer of magnets. The monolithic integration also enables the improvement of the performance of the reflective device, by bypassing, in particular, the mechanical stresses which can be imposed by a heterogenous assembly.

### BRIEF DESCRIPTION OF THE FIGURES

The aims, objectives, as well as the features and advantages of the invention will best emerge from the detailed description of an embodiment of the latter, which is illustrated by the following accompanying drawings, in which:

FIG. 1 schematically illustrates a magnetic actuation reflective device in an orthonormal system, comprising the axes X, Y, Z, according to an example of an embodiment.

FIGS. 2A and 2B schematically illustrate along transverse cross-sections YZ, a magnet comprising a stack of bilayers based on antiferromagnetic and ferromagnetic materials, manufactured by deposition according to the present invention, according to an example of an embodiment.

FIGS. 3, 4, 5A, 6A and 7A schematically illustrate along a plane XY of the top views of different examples of embodiments of the reflective device, according to several embodiments of the present invention.

FIGS. 5B, 6B and 7B schematically illustrate along transverse cross-sections XZ or YZ, the different examples of embodiments of the reflective device illustrated in FIGS. 5A, 6A and 7A.

FIG. 8A schematically illustrates along a plane XY, a top view of the reflective device, according to another embodiment of the present invention.

FIG. 8B schematically illustrates along a transverse cross-section YZ, the reflective device illustrated in FIG. 8A.

FIGS. 9A and 10A schematically illustrate along a plane XY, two examples of configurations of the actuator module of the reflective device according to the present invention.

FIGS. 9B and 10B represent graphs of the magnetic field produced by the at least one magnet according to a distance g between the at least one magnet and the electric line, obtained by calculations made for each of the two configurations illustrated in FIGS. 9A and 10A respectively.

FIGS. 11A, 12A, 13A and 14A schematically illustrate along a plane XY, top views of the different steps of the method for manufacturing the reflective device, according to an embodiment of the present invention.

FIGS. 11B, 12B, 13B and 14B schematically illustrate along transverse cross-sections XZ or YZ, the different steps of the method for manufacturing the reflective device, according to an embodiment of the present invention.

FIGS. 15A, 15B, 15C and 15D schematically illustrate along transverse cross-sections YZ, the steps of manufacturing an actuator module according to a first example.

FIGS. 16A to 16F schematically illustrate along transverse cross-sections YZ, the steps of manufacturing an actuator module according to a second example.

FIGS. 17A to 17I schematically illustrate along transverse cross-sections YZ, the steps of manufacturing an actuator module according to a third example.

In the figures in transverse cross-sections, cutting planes are indicated (A-A′, B-B′, . . . , N-N′) with cross references to the cutting planes of the corresponding figures.

The drawings are given as examples and are not limiting of the invention. They constitute principle schematic representations intended to facilitate the understanding of the invention, and are not necessarily to the scale of practical applications. In particular, in the principle diagrams, the thicknesses and/or the dimensions of the different layers, patterns and raised elements are not representative of reality.

### DETAILED DESCRIPTION

Before starting a detailed review of embodiments of the invention, optional features are stated below, which can optionally be used in association or alternatively.

According to an example, the first and second sublayers are superposed. More specifically, the second sublayer based on a ferromagnetic material can be superposed to the first sublayer based on an antiferromagnetic material.

According to an example, the at least one magnet is secured to the substrate without the means of an adhesive material or of a mechanical fixing or of a welding. The magnet is integrated to the reflective device homogeneously and monolithically, i.e. without resorting to assembly methods such as welding, mechanical fixing, or using an adhesive material. This homogeneous and monolithic integration improves the compactness of the reflective device and facilitates its manufacture.

According to an example, the magnet is directly in contact with the substrate, and preferably without an adhesive interface.

According to an example, the at least one magnetisation (M) direction is in the main extension plane of the stack, and for example, of the bilayer.

According to an example, the at least one magnet and the at least one electric line are separated by a shortest distance g between the at least one magnet and the at least one electric line, the distance g being greater than or equal to 500 nm. According to an example, the distance g is less than or equal to 7 μm, preferably less than or equal to 5 μm.

The distance g separating the magnet and the electric line is a parameter which has a significant impact on the intensity of the motor force F_{L}. The closer the magnets and the electric line are, the greater the Laplace force F_{L} is. Reducing the distance g makes it possible to facilitate the magnetic actuation of the mirror. This therefore enables a reduction of the energy consumption necessary for the actuation of the mirror.

According to an example, the second sublayer based on a ferromagnetic material has a thickness e₄ of between 2 nm and 50 nm, preferably between 10 nm and 50 nm.

According to an example, the first sublayer based on an antiferromagnetic material has a thickness e₃ of between 5 nm and 50 nm, preferably between 5 nm and 30 nm.

The thicknesses e₃ and e₄ can be advantageously optimised for each pair of ferromagnetic and antiferromagnetic materials. Preferably, the thickness e₃ of the sublayers based on an antiferromagnetic material is minimised, and the thickness e₄ of the sublayers based on a ferromagnetic material is maximised, while preserving a significant exchange interaction between the two materials. As an example, for a PtMn-based antiferromagnetic material, the thickness e₃ is chosen preferably around 20 nm, preferably around 12 nm, and the thickness e₄ of the ferromagnetic sublayers can be around 20 nm. According to another example, for an IrMn-based antiferromagnetic material, the thickness e₃ is chosen preferably around 8 nm, preferably around 5 nm, and the thickness e₄ of the ferromagnetic sublayers can be chosen around 20 nm. According to another example, for an NiMn-based antiferromagnetic material, the thickness e₃ is chosen preferably around 50 nm, and the thickness e₄ of the ferromagnetic sublayers can be chosen around 50 nm.

According to an example, the stack of the at least one magnet has a thickness of between 700 nm and 5 μm, preferably between 900 nm and 2 μm, and even more preferably, equal to 1 μm.

The effective magnetic thickness of the magnet is the sum of the thicknesses of all the ferromagnetic sublayers. Indeed, the antiferromagnetic material has substantially compensated magnetic moments, and consequently, does not produce a magnetic field, or produces an extremely weak magnetic field. These are mainly the magnetic moments present in the ferromagnetic material which contribute to the actual magnetisation of the magnet. The effective magnetic thickness can be substantially between 350 nm and 2.5 μm, preferably between 450 nm and 1 μm, and even more preferably can be substantially equal to 0.5 μm, according to the number of ferromagnetic sublayers.

According to an example, the stack of the at least one magnet comprises N superposed bilayers, N being an integer of between 10 and 50.

The number N of bilayers determines the total thickness, as well as the actual magnetisation of the magnet.

According to an example, the width of the magnet is around 200 μm.

According to an example, the length of the magnet is around 5 mm.

The reduced dimensions of the magnet make it possible to decrease the bulk of the device and to reduce the energy consumption of the reflective device.

According to an example, the actuator module is configured such that two motor forces are exerted on the second mobile part of the substrate, said forces being opposite directions from one another.

According to an example, the actuator module comprising at least two magnets, the at least one electric line being disposed on the second mobile part of the substrate securely to the mirror, the at least two magnets being respectively disposed on the first part on either side of the at least one electric line with respect to the axis of rotation of the mirror.

According to an example, the actuator module comprising at least two electric lines, the at least one magnet being disposed on the second mobile part of the substrate securely to the mirror, the at least two electric lines being respectively disposed on the first part of the substrate on either side of the at least one magnet with respect to the axis of rotation of the mirror.

These two configurations enable the generation of two Laplace forces which will be exerted along two opposite directions on either side of the second mobile part of the substrate, to facilitate the rotation of the mirror.

The configuration in which the electric line is disposed on the second mobile part of the substrate has the advantage of lightening the weight of the mobile part and of facilitating the rotation of this mobile part.

According to an example, the actuator module comprises at least two magnets, the at least one electric line being disposed on the second mobile part of the substrate securely to the mirror, the at least two magnets being respectively disposed on the first part on either side of the at least one electric line with respect to the axis of rotation of the mirror, in which the second mobile part of the substrate has a recess around which the at least one electric line forms a loop, the reflective device further comprising a third magnet secured to the first part of the substrate and disposed in the recess.

The recess in the second mobile part makes it possible to lighten the weight of the mobile part and to facilitate its rotation. Adding a magnet makes it possible to increase the intensity of the Laplace forces generated in order to further facilitate the rotation of the mirror.

According to an example, the mirror surmounts one from among the at least one magnet and the at least one electric line.

The integration of the magnet or of the electric line below the mirror makes it possible to optimise the compactness of the device.

According to an example, the mirror comprises a metal reflective layer, preferably gold (Au)- or aluminium (Al)-based.

According to an example, the mirror comprises a Bragg stack.

According to an example, the at least one magnet comprises a plurality of sub-magnets juxtaposed with one another, each sub-magnet being bar-shaped and comprising the stack of at least one bilayer.

The division of the magnet into parallel bar-shaped sub-magnets, such that each bar has a significant length/width ratio, makes it possible to preserve a good alignment of the magnetic moments along the main extension direction of the bar.

Through the longilinear shape of the bars, the magnetisation can naturally indeed by aligned along their main directions, i.e. the direction in which their length is measured, during the manufacture of the magnet, and more specifically, when the magnetic annealing is performed. The orientation of the magnetisation direction is made reliable, which makes the actuation of the mirror reliable. This can be particularly advantageous for manufacturing sub-magnets having two distinct magnetisation directions.

According to an example, the sub-magnets form a matrix along at least one dimension, by being juxtaposed along a direction perpendicular to their main extension direction and parallel to the main extension plane of the substrate.

According to an example, the sub-magnets have magnetisation directions (M) which are distinct from one another.

Thus, Laplace forces can be generated in different directions. This can, in particular, make it possible to actuate a rotation of the mirror about two axes of rotation.

According to an example, the sub-magnets are separated by a non-magnetic material, preferably silicon oxide (SiO₂)-based.

According to an example, the at least one magnet comprises a plurality of matrices of superposed sub-magnets, along a direction normal to the main extension direction of the stack or equivalently, of the substrate. The superposition of the matrices of magnetised bars along the same direction, makes it possible to increase the actual magnetisation of the magnet.

According to an example, the electrically conductive material is based on a metal, such as aluminium or copper, preferably copper-based.

According to an example, the electric line is connected to an electrical power source.

This source makes it possible to power the line or the electric coil with a current which interacts with the magnetic field coming from the magnet to generate a so-called motor Laplace force F_{L}, the direction of which depends on the direction of the electric current and on the direction of the magnetisation of the magnet.

According to an example, the ferromagnetic material is CoFe-based, and the antiferromagnetic material is PtMn- or IrMn-based.

The choice of these pairs of ferromagnetic and antiferromagnetic materials, makes it possible, on the one hand, to improve the saturation magnetisation Mₛ in the main extension plane of the bilayer, which improves the generation of the motor force F_{L}. On the other hand, this makes it possible to simplify the integration of the magnet, for example, by physical vapour deposition (PVD).

According to an example, the CoFe composition of the ferromagnetic material is richer in cobalt (Co) than in iron (Fe).

This makes it possible to improve the exchange interaction between the two ferromagnetic and antiferromagnetic materials, and consequently, improve the resistance of the magnet to magnetic shocks. However, this tends to decrease the saturation magnetisation Mₛ.

According to an example, the CoFe composition of the ferromagnetic material is richer in iron (Fe) than in cobalt (Co).

This makes it possible to increase the saturation magnetisation Mₛ. However, this tends to decrease the exchange interaction between the two ferromagnetic and antiferromagnetic materials.

According to an example, the heat treatment of the stack is performed at a temperature greater than or equal to 265° C. for an IrMn-based antiferromagnetic material.

According to an example, the heat treatment of the stack is performed at a temperature greater than or equal to 290° C. for a PtMn-based antiferromagnetic material.

According to an example, the heat treatment of the stack is performed for a duration greater than or equal to 1 hour.

The heat treatment is often performed at a temperature greater than the blocking temperature of the bilayer from which the exchange interaction between the antiferromagnetic sublayer and the ferromagnetic sublayer disappears. This makes it possible to reorient the magnetic moments in the ferromagnetic material along the direction of the external magnetic field applied. After the performance of the heat treatment and the cooling of the magnet to a temperature less than the blocking temperature, the exchange interaction is reestablished, and the magnetic moments in the ferromagnetic material are frozen along the desired direction, which preferably, is in the main extension plane of the bilayer.

According to an example, the heat treatment is performed under the application of a magnetic field having a direction which forms a 45° angle with the main extension direction of the sub-magnets.

This makes it possible to obtain, at the end of the heat treatment, two perpendicular magnetisation directions, which makes it possible to actuate a rotation of the mirror about two axes of rotation.

According to an example, the intensity of the magnetic field applied during at least some of the heat treatment, and according to an example during the entire heat treatment, is greater than or equal to 1 T.

According to an example, the formation of the actuator module, further comprises:
an etching of the stack deposited so as to form two first distinct magnets, separated by a space exposing internal flanks of the two first magnets and the upper face of the substrate,

According to an example, the formation of the actuator module, further comprises:
a deposition of a resin layer on the two first magnets, so as to cover the surface and the internal flanks of the two first magnets and to define a pattern intended for the formation of the at least one electric line between the two first magnets,
the deposition of the electrically conductive material in the pattern defined in the preceding step, to form the at least one electric line,
a removal of the resin layer after the deposition of the electrically conductive material.

According to an example, the formation of the actuator module further comprises:
the deposition of an electrically conductive material layer on the two first magnets so as to cover at least the surface of the two first magnets, and to fill at least partially, and preferably fully, the space between the two first magnets,
an etching of the electrically conductive material layer between the two first magnets so as to form two trenches in the electrically conductive material layer delimiting an electric line separated from the two magnets, preferably without exposing the internal flanks of the two first magnets.

According to an example, the formation of the actuator module further comprises:
a deposition of a first oxide layer on the two first magnets so as to cover the surface and the flanks of the two first magnets, and to fill at least partially, and preferably fully, the space between the two first magnets,
a partial etching of the first oxide layer in vertical alignment with the space between the two first magnets, substantially up to the plane comprising the upper face of the two first magnets, in order to form a pattern intended for the formation of the at least one electric line,
the deposition of an electrically conductive material layer on the first oxide layer, in order to fill at least partially, and preferably fully, the pattern defined in the preceding step, to form the at least one electric line,
a planarisation of the electrically conductive material layer up to substantially reaching the first oxide layer,
a formation of two distinct second magnets above the first oxide layer and in vertical alignment with the two first magnets,
a deposition of a second oxide layer so as to cover the surface and the flanks of the two second magnets, and to fill at least partially, and preferably fully, the space between the two second magnets.

According to an example, the second oxide layer is planarised so as to expose the upper face of the two second magnets.

According to an example, the deposition of the first oxide layer is followed by the following steps:
an etching of the first oxide layer between the two first magnets so as to expose the underlying substrate, and preferably expose the internal flanks of the two first magnets,
a deposition of a resin layer on the first magnets so as to define a pattern between the two first magnets separated from the internal flanks of the two first magnets, intended for the formation of the at least one electric line, for example, the deposition of the resin layer on the first magnets is configured so as to cover at least the internal flanks of the two first magnets, and
the deposition of the electrically conductive material in the pattern defined in the preceding step, to form the at least one electric line,
a removal of the resin layer,
a deposition of a second oxide layer so as to fill at least partially, and preferably fully, the space between the at least one electric line formed and the two second magnets.

According to an example, the deposition of the first oxide layer is followed by the following steps:
a partial etching of the first oxide layer between the two first magnets so as to expose at least partially the upper face of the substrate, without exposing the internal flanks of the two first magnets, and to define a pattern intended for the formation of the at least one electric line,
the deposition of the electrically conductive material in the pattern defined in the preceding step, to form the at least one electric line,
a planarisation of the electrically conductive material layer, preferably without exposing the upper face of the two first magnets,
a deposition of a second oxide layer so as to cover the two first magnets and the at least one electric line.

It is specified that, in the scope of the present invention, the terms “on”, “surmounts”, “covers”, “underlying”, “opposite” and their equivalents do not necessarily mean “in contact with”. Thus, for example, the arrangement of a first layer on a second layer, does not compulsorily mean that the two layers are directly in contact with one another, but means that the first layer covers at least partially the second layer by being either directly in contact with it, or by being separated from it by at least one other layer or at least one other element.

By a substrate, a layer based on a species A, this means a substrate, a layer comprising this species A only or this species A and optionally other species.

By a parameter “substantially equal to/greater than/less than” a given value, this means that this parameter is equal to/greater than/less than the given value, plus or minus 10% of this value. By a parameter “substantially between” two given values, this means that this parameter is, as a minimum, equal to the lowest given value, plus or minus 10% of this value, and as a maximum, equal to the greatest given value, plus or minus 10% of this value.

A preferably orthonormal system, comprising the axes X, Y, Z is represented in the accompanying figures.

It is specified that in the scope of the present invention, the thickness of a layer or of the substrate is measured along a direction perpendicular to the surface according to which this layer or this substrate has its maximum extension. The thickness is thus taken along a direction perpendicular to the main faces of the layer or of the substrate on which the different layers rest. More specifically, the thickness can be taken along the direction Z.

In the present patent application, the term “secured” used to qualify the connection between two parts means that the two parts are connected/fixed to one another, according to all degrees of freedom, except for if it is explicitly specified differently. For example, if it is indicated that two parts are secured in translation along a direction X, this means that the parts can be mobile against one another, possibly according to several degrees of freedom, excluding the freedom in translation along the direction X. In other words, if a part is moved along the direction X, the other part makes the same movement.

In the detailed description below, use can be made of terms such as “horizontal”, “vertical”, “longitudinal”, “transverse”, “upper”, “lower”, “top”, “bottom”, “front”, “rear”, “inner”, “outer”. These terms must be interpreted relative to the normal position of the reflective device and the propagation of the light beams, and in particular, of the incident light beam, relative to the reflective device.

The steps of the method are understood, in the broad sense, as the carrying out of a part of the method and can optionally be carried out in several substeps. Several embodiments of the invention implementing successive steps of the manufacturing method are described below. Unless explicitly mentioned, the adjective “successive” does not necessarily imply, even if this is generally preferred, that the steps immediately follow one another, intermediate steps being able to separate them.

Moreover, the term “step” does not compulsorily mean that the actions carried out during a step are simultaneous or immediately successive. Certain actions of a first step can, in particular, be followed by actions linked to a different step, and other actions of the first step can then be resumed. Thus, the term “step” does not necessarily mean single and inseparable actions over time and in the sequence of phases of the method.

In the scope of the present invention, resin is conventionally qualified as an organic or organo-mineral material being able to be shaped by an exposure to an electron, photon or X-ray beam, or mechanically.

As an example, resins conventionally used in microelectronics, polystyrene (PS)-based, methacrylate-based (for example, polymethyl methacrylate PMMA), hydrosilsesquioxane (HSQ)-based, polyhydroxystyrene (PHS)-based resins, etc. can be mentioned. The interest of using a resin is that it is easy to deposit a significant thickness there, of several hundred nanometres to several micrometres.

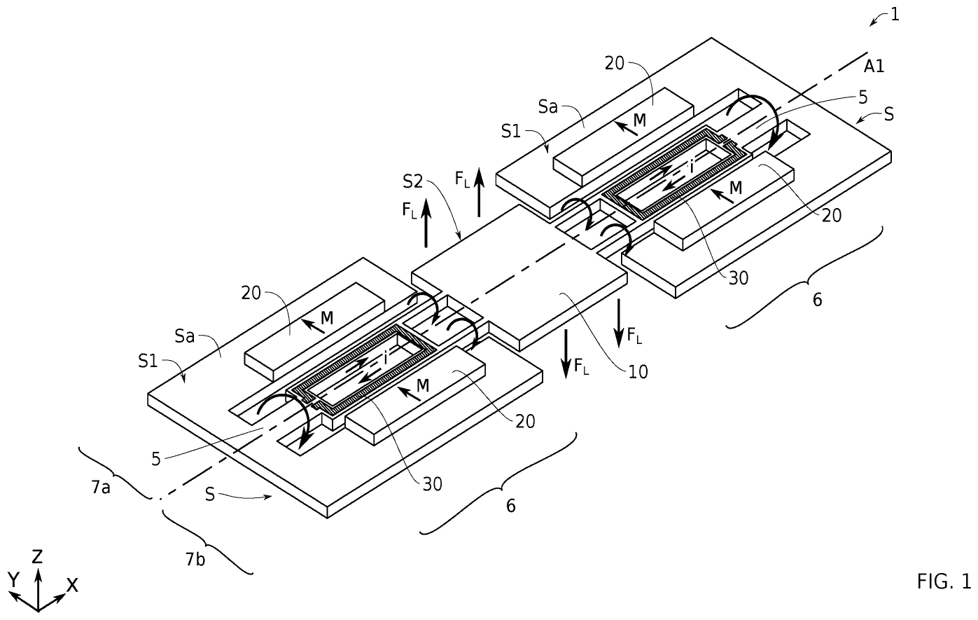

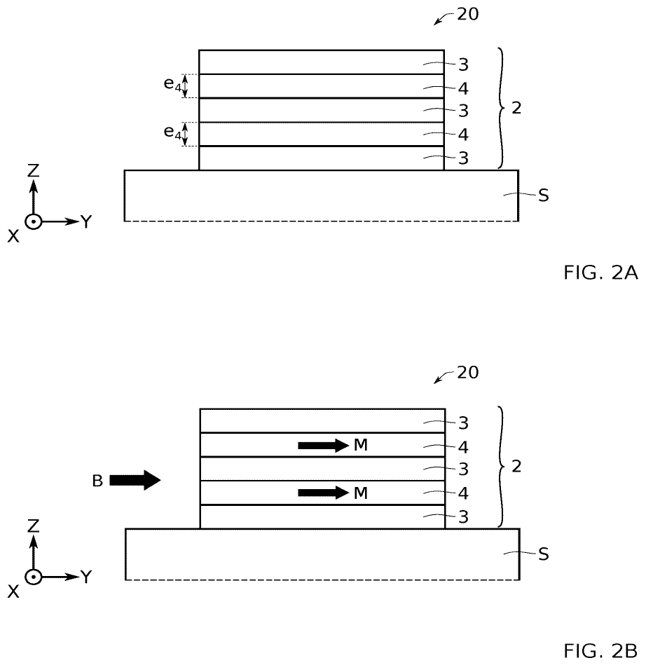

A reflective device 1 is now described in reference to FIGS. 1, 2A and 2B, according to an example of an embodiment.

FIG. 1 illustrates a magnetic actuation reflective device 1 intended to reflect an incident light beam to form a reflected beam being propagated in a determined direction, typically to a target. The reflective device 1 comprises a substrate S extending, for example, into a plane XY defined by a direction X and a direction Y perpendicular to the direction X. The substrate S comprises a first part S1, and a second part S2 which is mobile with respect to the first part S1.

A mirror 10 enabling the reception of the incident beam and the formation of the reflected beam, is disposed securely on the second part S2 of the substrate S. The mirror 10 is configured so as to be pivoted about at least one axis of rotation A1. The axis of rotation A1 is defined, for example, along the length of the second mobile part S2 which extends along the direction X on either side of the mirror 10 to join the first part S1.

The reflective device 1, for example, illustrated in FIG. 1, can comprise at least one actuator module 6. Each actuator module 6 comprises at least one magnet 20 having a magnetisation M direction, and at least one electric line 30. The electric line 30 is based on an electrically conductive material 35 and is powered by an electric current i.

The current i passing through the electric line 30 interacts with the magnetic field coming from the magnet 20 to generate a Laplace force F_{L} called “motor force”. This motor force F_{L} makes it possible to actuate the pivoting of the second part S2, and therefore of the mirror 10 about the axis of rotation A1. The direction of the motor force F_{L} is typically substantially perpendicular to the magnetisation M direction, and to the circulation direction of the current i. In addition, the direction of the motor force F_{L} depends on the orientation of the magnetisation M direction as well as the direction of the current i. The magnetisation M direction preferably being fixed, the direction of the motor force F_{L} is determined by the direction of the current i passing through the electric line 30. It is therefore understood that the mirror 10 can be rotated in one direction or in the opposite direction.

The mirror 10 therefore moves from a rest position, i.e. a balanced position without magnetic actuation, to a pivoted position, by pivoting about the axis of rotation A1. Once the mirror 10 is rotated, it can be returned to a rest position. This return to the rest position can be done by returning to the balanced position, by stopping the magnetic drive.

Typically, the second part S2 of the substrate is articulated in rotation with the first part S1 through a hinge 5, and more specifically, a deformable hinge 5 twisting about the axis of rotation A1. Conventionally, this hinge 5 can comprise a portion of the substrate forming a twisting, deformable bar, connecting the first part S1 and the second part S2 of the substrate. During the magnetic actuation, this hinge 5 can be deformed, twisting about the axis of rotation A1 in order to enable the rotation of the second part S2 of the substrate, and therefore of the mirror 10. When the motor force is no longer generated, the twisting force of the hinge 5 can lead to the return to the balanced position.

It is noted that in the configuration of the reflective device 1 illustrated in FIG. 1, two actuator modules 6 are represented. According to the example illustrated, the reflective device comprises two actuator modules 6 disposed on either side of the mirror 10 along a direction parallel to the axis of rotation A1 of the mirror 10, so as to increase the result of the motor forces generated. The rotation of the mirror 10 is therefore facilitated. The pivoting of the mirror 10 can however be driven by one single actuator module 6. For simplification and in a non-limiting manner, one single actuator module 6 will be represented in the figures and the embodiments described below.

As illustrated, for example, in FIGS. 2A and 2B, the magnet 20 comprises a stack 2 of at least one bilayer along a direction Z perpendicular to the directions X and Y. Each bilayer comprises a first sublayer 3 with the basis, and preferably made, of an antiferromagnetic material, and a second sublayer 4 with the basis, and preferably made, of a ferromagnetic material. The superposition of a ferromagnetic material to an antiferromagnetic material, leads to an exchange interaction between the magnetic moments at the interface between the first sublayers 3 and the second sublayers 4, which freezes the magnetic moments, in particular, in the second ferromagnetic sublayers 4.

The second sublayer 4 can be superposed to the first sublayer 3. The superposition of an antiferromagnetic material to a ferromagnetic material, improves the resistance of the magnet 20 to magnetic shocks. The stack 2 can comprise N bilayers, N being an integer of between 10 and 50. FIGS. 2A and 2B show an example with N=2.

The stack 2 is manufactured by microelectronic deposition techniques. This makes it possible to integrate the magnet 20 to the reflective device 1, by depositing the stack 2 on the substrate S, homogeneously with the deposition of the mirror 10 and of the electric line 30 during the manufacturing method.

Following the deposition of the stack 2, the magnetisation M direction can be defined during the method as will be described in detail below. This magnetisation M direction is preferably taken in the plane XY which makes it possible to generate a motor force F_{L} along the direction Z.

The actuator module 6 described above, comprising at least one magnet 20 and at least one electric line 30, can be configured in several ways. According to an example, the actuator module 6 is configured such that two motor forces are exerted on the second mobile part S2 of the substrate, in the opposite direction between the two opposite edges 7a, 7b, of the mobile part S2 with respect to the axis of rotation A1. Thus, the rotation of the mirror 10 is facilitated.

For this, according to a first embodiment, an electric line 30 forming a loop or a coil is disposed on the second mobile part S2, and two magnets 20 are disposed on the first part S1 on either side of the mobile part S2, along a direction perpendicular to the axis of rotation A1. Several variants of this first embodiment which will be described initially, making it possible, in particular, to improve the generation of the motor force F_{L} and the compactness of the reflective device 1. According to a second embodiment, two electric lines 30 are disposed on the first part S1, on either side of a magnet disposed on the mobile part S2, along a direction perpendicular to the axis of rotation A1. This second embodiment will be described secondly in the description below.

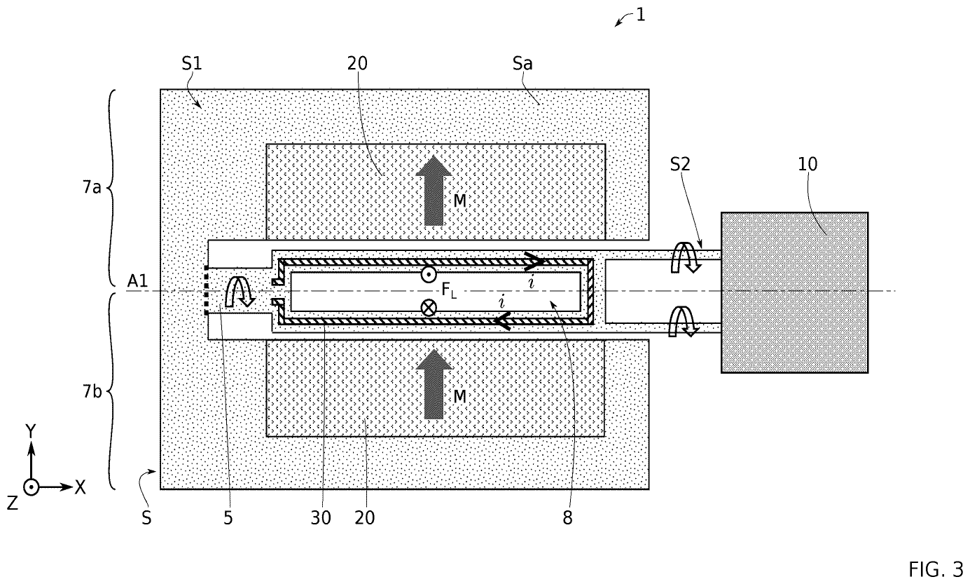

FIG. 3 illustrates a top view along the plane XY of a reflective device 1, according to the first embodiment of the present invention. The electric line 30 can form a loop or a coil, such that the current i is propagated in the electric line 30 on a first part of the loop, disposed facing an edge of the mobile part S2. The current i is therefore propagated in a first direction with respect to the reflective device. The current i can be propagated in the electric line 30 on a second part of the loop, disposed facing an opposite edge, with respect to the axis of rotation A1, of the mobile part S2. The current i is thus propagated in a second direction with respect to the reflective device, opposite the first. According to this first embodiment, the electric line 30 can be disposed on the second mobile part S2 of the substrate S securely to the mirror 10. Two magnets 20 preferably have one same magnetisation M direction, can be disposed respectively on the first part S1 on either side of the electric line 30 along a direction perpendicular to the axis of rotation A1 of the mirror 10. The current i interacts with the first magnet 20 of the first part of the loop to generate a motor force F_{L} along the direction Z along a first direction, then interacts with the second magnet 20 of the second part of the loop to generate a motor force F_{L} along a second direction opposite the first direction. These two forces which are opposite to one another, facilitate the rotation of the second mobile part S2. The inversion of the circulation direction of the current i in the loop, with respect to the reflective device, induces an inversion of the direction of the two motor forces, which enables a pivoting of the mirror 10 about the axis of rotation A1 in a positive or negative direction with respect to an axis perpendicular to the axis of rotation A1. FIG. 3 illustrates an example of pivoting of the mirror 10 about the axis of rotation A1 defined along the direction X, in a negative direction of the direction Y.

The arrangement of the electric line 30 on the second mobile part S2, further makes it possible to reduce the weight of this second mobile part S2, which facilitates the rotation of the mirror 10. According to an example, the second mobile part S2 can advantageously have a recess 8 around which the electric line 30 forms the loop, which makes it possible to reduce, in addition, the weight of the second mobile part S2.

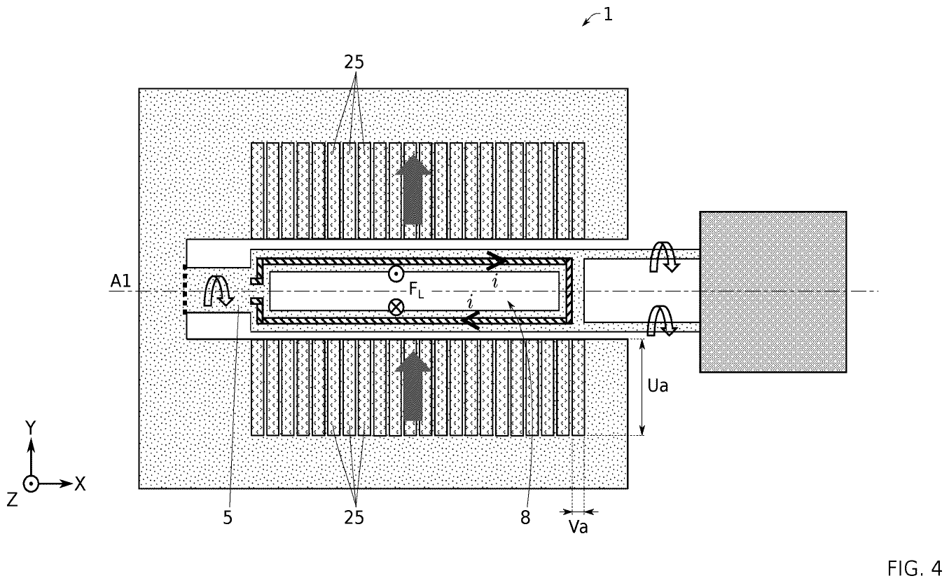

According to a variant illustrated in FIG. 4, each magnet 20 can comprise a plurality of sub-magnets 25 juxtaposed with one another. According to this example, each sub-magnet 25 is bar-shaped and comprises the stack 2 of bilayers described above. The sub-magnets 25 are more specifically juxtaposed along the direction X, along a direction substantially perpendicular to their main extension direction Y. This configuration makes it possible to preserve a good alignment of the magnetic moments of the magnet 20 along the main extension direction of the bar, during manufacture. Through the longilinear shape of the sub-magnets 25, the magnetisation M can naturally indeed be aligned along their main directions, i.e. the direction in which their length Uₐ is measured, during the manufacture of the magnet 20 and more specifically, when a heat treatment is performed. The orientation of the magnetisation M direction is made reliable, which makes the actuation of the mirror 10 reliable. The sub-magnets 25 are preferably substantially parallel to one another, and each sub-magnet 25 advantageously has a high aspect ratio with a length Uₐ along the direction Y, over a width Vₐ along the direction Y, preferably Uₐ/Vₐ≥10.

According to an example of an embodiment, the sub-magnets 25 can have magnetisation M directions which are distinct from one another. Thus, Laplace forces F_{L} can be generated in different directions. This can, in particular, make it possible to actuate a rotation of the mirror 10 about two different axes of rotation.

According to an example not illustrated, the sub-magnets 25 are separated by a non-magnetic material, preferably silicon oxide (SiO₂)-based. This makes it possible to form a matrix of sub-magnets 25 which can be superposed with a plurality of matrices of sub-magnets 25. The superposition of the matrices of magnetised bars along the same magnetisation M direction, makes it possible to increase the actual magnetisation of the magnet.

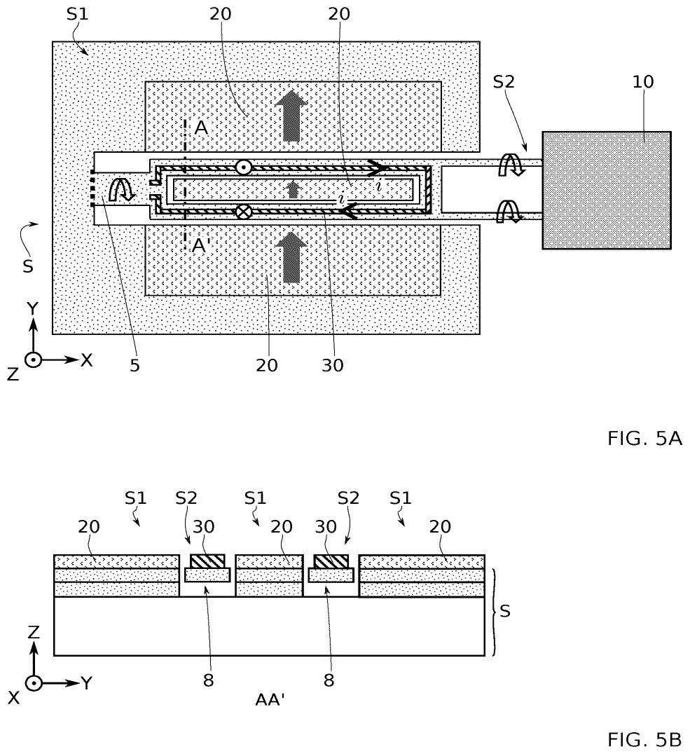

As illustrated in FIGS. 5A and 5B, according to an example, the reflective device 1 can further comprise, a third magnet 20 secured to the first part S1 of the substrate S and disposed in the recess 8. The addition of a third magnet 20 at the centre of the electric loop, makes it possible to increase the intensity of the Laplace forces F_{L} generated in opposite directions, which further facilitates the rotation of the mirror 10. Results of calculations performed according to different configurations of the actuator module 6, show the effect of the addition of a third magnet 20 on the intensity of the motor force F_{L}. These results will be presented below in the present description.

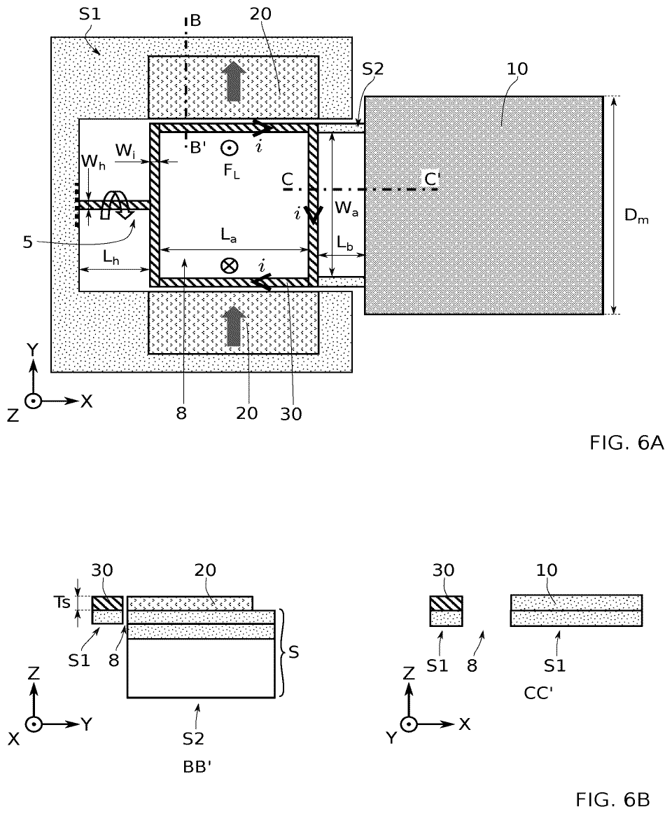

FIGS. 6A and 6B illustrate an example of an embodiment further improving the compactness of the reflective device 1. In this example, the dimensions of the second mobile part S2 are reduced. Indeed, the recess 8 in this part extends up to in vertical alignment with the electric line 30, as transverse cross-sections BB′ and CC′ along the planes YZ and XZ show, respectively. This makes it possible to further reduce the weight of the second mobile part S2 which facilitates the rotation actuation of the mirror 10. It is understood that the dimensions of the elements composing the reflective device 1 can be adjusted according to the architectures considered.

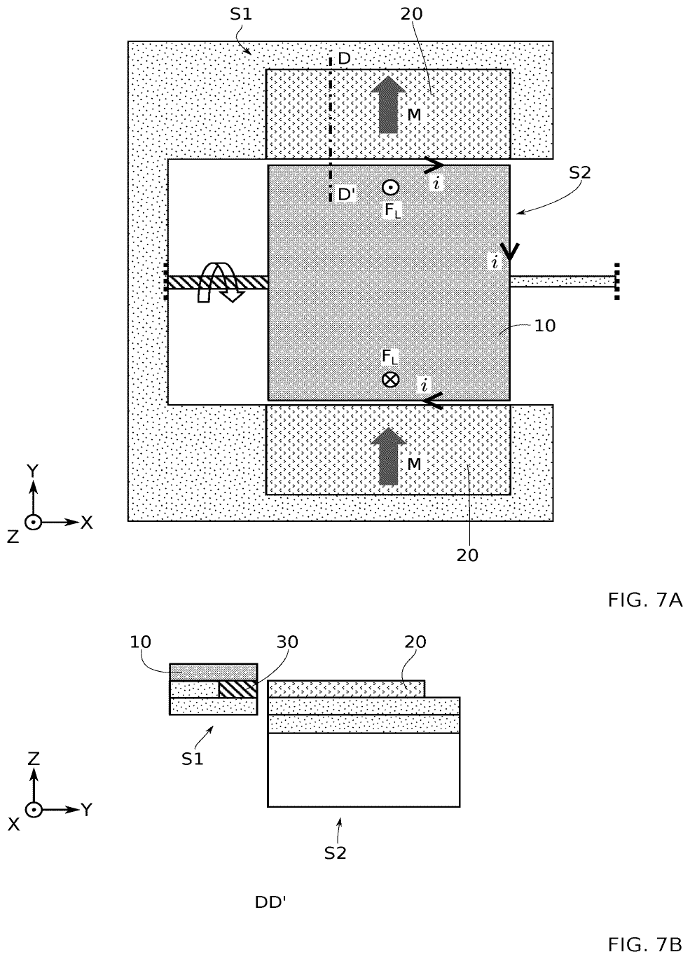

As illustrated in FIGS. 7A and 7B, according to another example, the mirror 10 can be disposed in superposition with the electric line 30 as the transverse cross-section DD′ along the plane YZ shows. This makes it possible to improve the compactness of the reflective device 1.

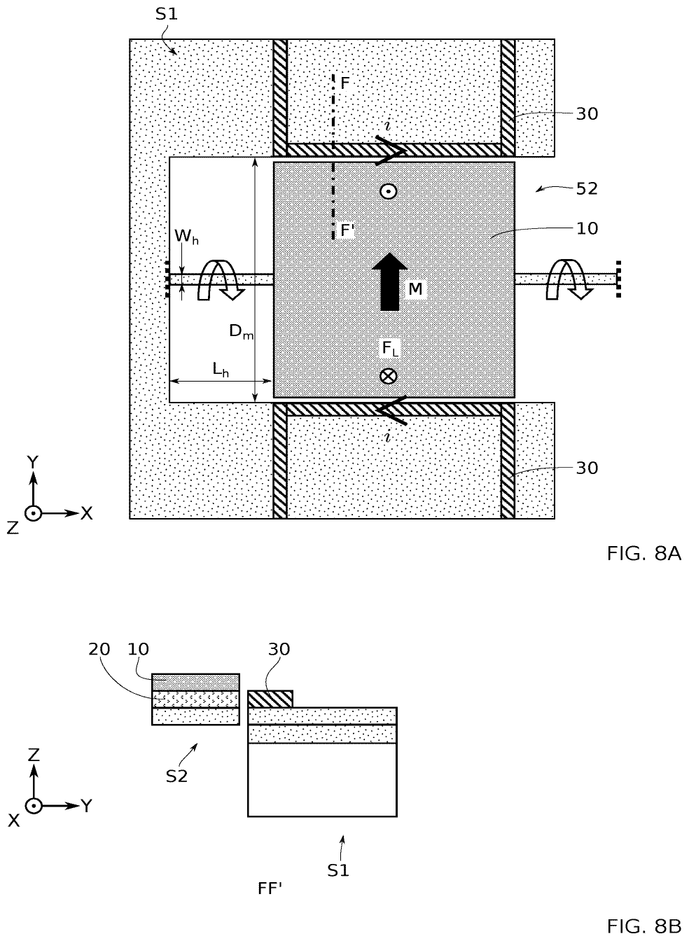

FIGS. 8A and 8B illustrate a variant of an embodiment of the present invention. According to this variant, the magnet 20 is disposed on the second mobile part S2 of the substrate S. The mirror 10 can more specifically be superposed with the magnet 20, as the transverse cross-section FF′ along the plane YZ shows. Two electric lines 30 are disposed on either side of the magnet 20 with respect to the axis of rotation A1, on the first part S1. A current i circulates in each of the electric lines 30 on either side of the magnet 20, along opposite directions, such that the Laplace forces F_{L} generated, are of opposite directions.

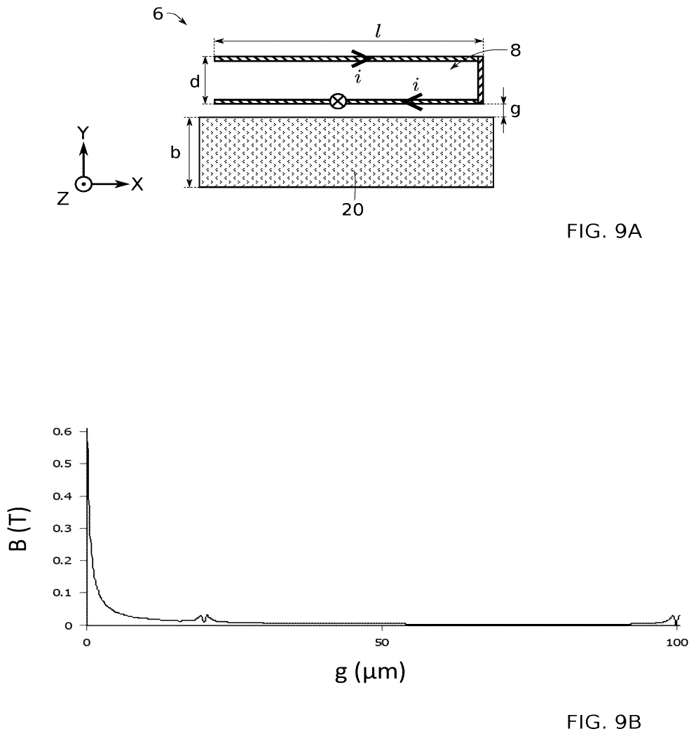

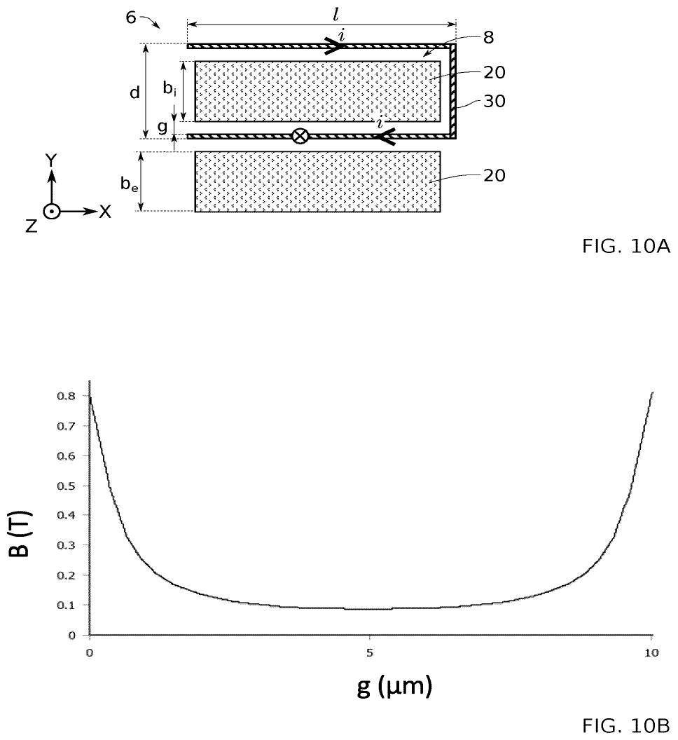

Now, the parameters which impact on the intensity of the Laplace force F_{L} generated by the interaction between the current i and the magnetic field coming from the at least one magnet 20 will be described. In a known manner, the intensity of F_{L} follows the following equation:

$${F}_{L} = B \times i \times l$$

Where B represents the intensity of the magnetic field produced by the magnet 20 at a distance g between the electric line 30 and the magnet 20 taken along the direction Y, i represents the intensity of the current i passing through the electric line 30, and/represents the length of the interaction between the current i and the magnetic field, which preferably corresponds to the length of the magnet 20. The Laplace force F_{L} depends on this distance g. In order to evaluate the impact of the distance g on the intensity of the force F_{L}, calculations have been performed for two different configurations, illustrated in FIGS. 9A and 10A.

FIG. 9A illustrated a first configuration in which one single magnet 20 interacts, on the one hand, with the loop-shaped electric line 30. Calculations according to the parameters presented in the table below, in reference to FIG. 9A, have been performed. In the examples presented, in order to simulate a stack 2 comprising ferromagnetic sublayers having a saturation magnetisation Mₛ of around 2.4 T and a thickness around equal to that of the antiferromagnetic sublayers, a permanent magnet having a saturation magnetisation Mₛ of around 1.2 T replaces the stack 2 in the calculations. As an example, this permanent magnet can simulate a stack 2 of 25 bilayers, comprising PtMn-based antiferromagnetic sublayers, each having a thickness of around 20 nm, and CoFe-based ferromagnetic sublayers having a 65% Fe and 35% Co composition, for example, and each having a thickness of around 20 nm.

| Parameters | Values | |
|---|---|---|
| Number of magnets | 1 | |
| Thickness of a magnet | 1 | μm |
| Maximum intensity of the magnetic | 1.2 | T |
| field generated by the magnet | | |
| Width b of the magnet along the direction y | 200 | μm |
| Length l of the magnet along the direction x | 5 | mm |
| Number of electric lines | 1 | |
| Thickness r of the electric line along the direction z | 1 | μm |
| Dimension d of the electric line along the direction y | 100 | μm |
| Intensity of the electric current | 100 | mA |

The results of the calculations show that most of these parameters have an impact which is proportional to their value on the intensity of the Laplace force F_{L}. The thickness r of the electric line 30 and the length l of the magnet 20 have an insignificant impact on this intensity. However, these parameters r and l, have an impact on the maximum intensity of the current i supported by the electric line 30, which defines the limit of the electromigration in the electric line. The distance g however has a high impact on the intensity of the motor force. The variation of the magnetic field B according to the distance g is represented in the graph of FIG. 9B. By increasing the distance g between the magnet 20 and the electric line 30, the intensity of the magnetic field produced by the magnet 20 decreases exponentially. This drastic variation of the intensity of the magnetic field according to the distance g, has a significant impact on the intensity of the Laplace force F_{L}. The closer the magnet 20 and the electric line 30 are, the greater the Laplace force F_{L} is, which facilitates the actuation of the pivoting of the mirror 10. In addition, this enables the reduction of energy consumption, as for a fixed current intensity value i, it is sufficient to reduce the distance g to increase the intensity of the motor force F_{L}. According to the graph of FIG. 9B, to obtain a significant motor force F_{L}, the distance g is preferably less than or equal to 7 μm, preferably less than or equal to 5 μm. These reduced values of the distance g are advantageously reachable thanks to the monolithic integration of the magnet 20 and the electric line 30. For a distance g equal to 5 μm, the intensity of the Laplace force F_{L} calculated is around 20.5 μN. In the case where two magnets 20 are disposed on either side of the mobile part S2, the sum of the absolute value forces is therefore 41 μN.

FIG. 10A illustrates an example in which two magnets 20 interact with the current i passing through the loop-shaped electric line 30. The first magnet 20 is disposed outside of the loop at a distance g of the electric line 30. The second magnet 20 is disposed at the centre of the loop at the same distance g from the electric line 30, for example, in a recess 8 of the mobile part S2 as described above. Calculations according to the parameters presented in the table below, in reference to FIG. 10A, have been performed.

| Parameters | Values | |
|---|---|---|
| Number of magnets | 2 | |
| Thickness of a magnet | 1 | μm |
| Total maximum intensity of the magnetic fields generated | 1.2 | T |
| by the magnets | | |
| Dimension bₑ of the external magnet along the direction y | 200 | μm |
| Dimension bᵢ of the external magnet along the direction y | 100 | μm |
| Length l of the magnet along the direction x | 5 | mm |
| Number of electric lines | 1 | |
| Thickness r of the electric line along the direction z | 1 | μm |
| Dimension d of the electric line along the direction y | 100 | μm |
| Intensity of the electric current | 100 | mA |

The variation of the magnetic field B according to the distance g is represented in the graph of FIG. 10B. This graph shows that for this configuration, in order to obtain a significant motor force F_{L}, the distance g has a significant impact. Preferably, the distance g is preferably less than or equal to 7 μm, preferably less than or equal to 5 μm. For a distance g equal to 5 μm, the intensity of the force F_{L} calculated for one same current intensity i as for that of the preceding configuration, is around 82 μN. This shows that by adding a magnet 20 inside the loop, the intensity of the force F_{L} is significantly increased. In the case where two magnets 20 are disposed on either side of the mobile part S2, the result of the forces is therefore 164 μN.

For each of the two embodiments described above, a set of dimensions of the second mobile part S2 is represented in the tables below. The optimisation of these dimensions makes it possible to optimise the rotation resonance frequency of the mirror 10 and the maximum static movement of the mirror 10 with respect to its balanced position.

According to the first embodiment and in reference to the example of the reflective device illustrated in FIGS. 6A and 6B, the second mobile part S2 can comprise:
A support of the mirror 10 of a dimension Dm along the direction Y,
A support of the electric line 30 having a recess 8, a dimension La along the direction X, a cross-section Wi along the direction X and a thickness Ts along the direction Z,
A hinge 5 connecting the support of the electric line 30 to the first part S1 of the substrate S, having a length Lh along the direction X and a width Wh along the direction Y,
Two bars separated from one another by a distance Wa along the direction Y, connecting the support of the electric line 30 to the support of the mirror 10, having a length Lb along the direction X.

The table below presents examples of values of the dimensions mentioned above:

| Parameter | Range of values | Optimal value | |
|---|---|---|---|
| Wₕ | 5 μm ≤ Wₕ ≤ 20 μm | 10 | μm |
| Wᵢ | 10 μm ≤ Wₕ ≤ 100 μm | 50 | μm |
| Lₕ | 50 μm ≤ Lₕ ≤ 1000 μm | 500 | μm |
| Lₐ | 500 μm ≤ Lₐ ≤ 2000 μm | 1000 | μm |
| L_{b} | 10 μm ≤ L_{b} ≤ 100 μm | 50 | μm |
| Tₛ | 5 μm ≤ Tₛ ≤ 20 μm | 11 | μm |
| Wₐ | 500 μm ≤ Wₐ ≤ 2000 μm | 1500 | μm |

The optimal value of the dimension Dm depends on the optical specifications of the reflective device 1. As an example, Dm can be equal to 2000 μm. As described above, the intensity of the Laplace force F_{L} depends on the parameters of the actuator module 6. As an example, the intensity of F_{L} can be equal to 50 μN. For the optimal values of the parameters presented in the table above and for the examples of given values of Dm and of F_{L}, the twisting resonance frequency is around 500 Hz, and the static movement of the mirror with respect to its balanced position is +10°.

In reference to the example of the reflective device illustrated in FIGS. 8A and 8B, the second mobile part S2 can comprise:
A support of the mirror 10, of a dimension Dm along the direction Y, the mirror 10 being superposed to the magnet 20,
A hinge 5 connecting the support of the mirror 10 to the first part S1 of the substrate S, having a length Lh along the direction X, a width Wh along the direction Y and a thickness ts along the direction Z.

The table below present examples of values of the dimensions mentioned above:

| Parameter | Range of values | Optimal value | |
|---|---|---|---|
| Wₕ | 5 μm ≤ Wₕ ≤ 20 μm | 10 | μm |
| Lₕ | 50 μm ≤ Lₕ ≤ 1000 μm | 500 | μm |
| tₛ | 5 μm ≤ tₛ ≤ 20 μm | 11 | μm |

For the optimal values of the parameters presented in the table above and for Dm equal to 2000 μm and F_{L} equal to 50 μN, the twisting resonance frequency is around 580 Hz, and the static movement of the mirror with respect to its balanced position is +13°

It is noted that the same parameters can be considered for the configuration illustrated in FIGS. 7A and 7B. In this configuration, the mass of the second mobile part S2 is lighter, the electric line 30 being lighter than the magnet 20, which decreases the twisting resonance frequency.

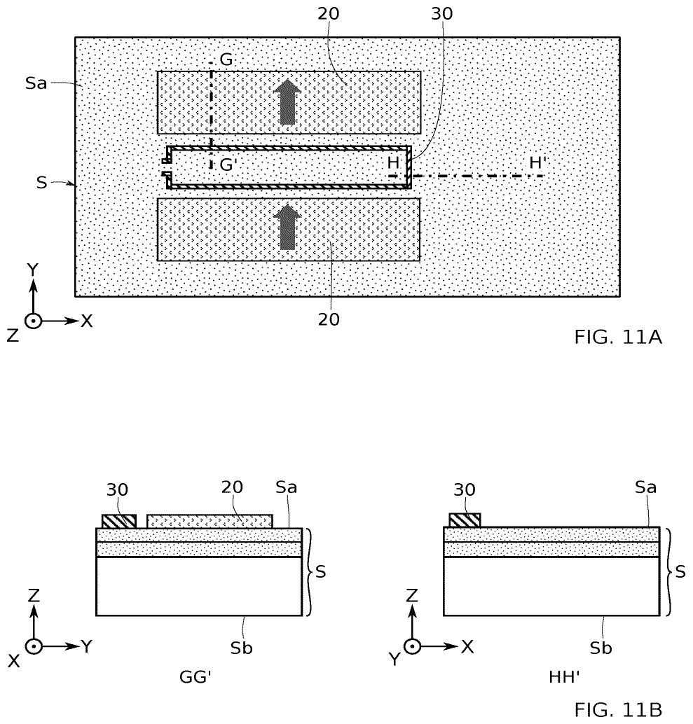

The method for manufacturing a reflective device 1 is described below, according to several particular examples of embodiments. For simplification, only the steps of manufacturing a reflective device 1, according to the first configuration of the first embodiment, are illustrated schematically in FIGS. 11A, 11B to 14A, 14B. A person skilled in the art will adapt these figures without difficulty to view the different steps of the method for manufacturing the reflective device 1 according to the other variants.

As illustrated in FIGS. 11A and 11B, a step of the method is to provide a substrate S extending along a plane parallel to the plane XY, and having an upper face Sa and a lower face Sb. The substrate S can be an SOI (silicon-on-insulator)-type substrate. These known substrates, comprise, according to common terminology for a person skilled in the art, a “bulk Si” carrier silicon substrate and a so-called “BOX” (buried oxide) silicon oxide layer.

An actuator module 6 is then formed on the upper face Sa of the substrate S. The formation of the actuator module 6 comprises a deposition of a magnet 20 by depositing a stack 2 of N bilayers comprising a first sublayer 3 and a second sublayer 4 based on antiferromagnetic and ferromagnetic materials respectively, as illustrated in FIG. 2A.

Following its deposition, the stack 2 is subjected to a heat treatment under the application of a magnetic field, as illustrated in FIG. 2B. The heat treatment is often performed at a temperature greater than a so-called “blocking” temperature. Beyond the blocking temperature, the exchange interaction between the first antiferromagnetic sublayer 3 and the second ferromagnetic sublayer 4 disappears. This makes it possible to reorient the magnetic moments in the ferromagnetic material according to the orientation of the external magnetic field applied. After the performance of the heat treatment and the cooling of the stack 2 to a temperature less than the blocking temperature, the exchange interaction is reestablished, and the magnetic moments in the ferromagnetic material are frozen along the desired direction, which preferably, is in the main extension plane of the bilayer. The thermal annealing is performed preferably by preserving an intensity of the external magnetic field greater than or equal to 1 T in the desired direction for the entire duration of the annealing, including the cooling. The thermal annealing can be performed just after the deposition of the magnet or later. Preferably, the thermal annealing can be performed at the end of the method.

The blocking temperature can therefore correspond to the ordering temperature of the antiferromagnetic material when the antiferromagnetic material is not magnetically ordered. A non-ordered antiferromagnetic material does not have exchange coupling after deposition on a ferromagnetic material. This blocking temperature is more specifically the temperature beyond which there is no longer exchange coupling between an antiferromagnetic material and a ferromagnetic material in contact when the antiferromagnetic material is magnetically ordered. This can be the Néel temperature, i.e. the temperature above which the antiferromagnetic material becomes paramagnetic. This blocking temperature is typically above 250° C. for a non-ordered antiferromagnetic material. For an ordered antiferromagnetic AF material, the blocking temperature is typically between 150° C. and 250° C.

The formation of the actuator module 6 further comprises a formation of an electric line 30 on the upper face Sa of the substrate S by deposition of an electrically conductive material 35. The electrically conductive material 35 can be based on a metal, such as aluminium or copper, preferably copper-based.

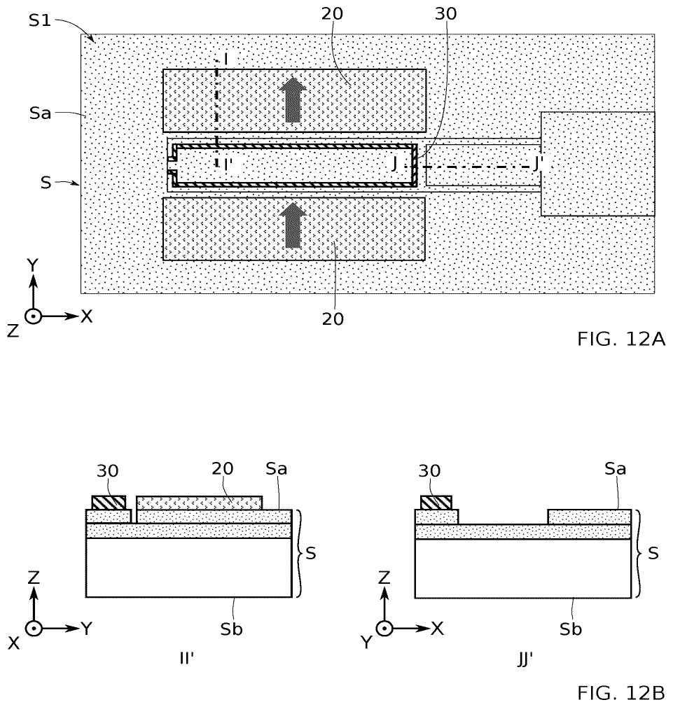

As illustrated in FIGS. 12A and 12B, a first partial etching from the upper face Sa of the substrate S is then performed. This first etching enables the removal of a part of the substrate S so as to separate the magnet 20 and the electric line 30, and to define a first part S1 and a second part S2 in the substrate S. The hinge 5 can at least partially be defined during this etching.

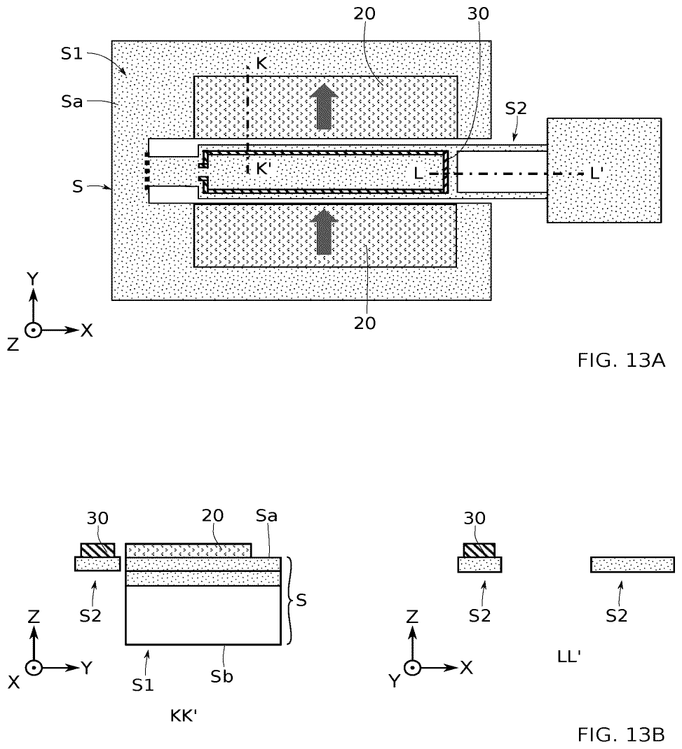

As illustrated in FIGS. 13A and 13B, a second etching can be performed from the lower face Sb of the substrate S. This second etching enables a partial disconnection of the second part S2 from the substrate, in order to attribute it a degree of freedom making it possible to make it pivot about an axis of rotation A1 which extends along the length of the part S2. This partial disconnection can be made possible, in particular, by the hinge 5. The transverse cross-sections KK′ and LL′ illustrated in FIG. 13B along the planes YZ and XZ respectively, show the separation of the second part S2 from the first part S1, the second mobile part S2 being surmounted by the electric line 30 according to the first embodiment. It is noted, that in reality, the substrate S preferably has a layer continuity between the parts S1 and S2, through the twisting deformable hinge 5. The first and the second etching can be dry etchings, preferably reactive ion etchings (RIE).

As illustrated in FIGS. 14A and 14B, a mirror 10 is formed on the second mobile part S2 of the substrate S, by a deposition of a reflective layer. This reflective layer can be based on a metal material, preferably gold (Au)-based or aluminium (Al)-based. It can also comprise a Bragg stack. The dimensions of the mirror 10 depend on optical specifications of the reflective device 1. The mirror 10 can have, for example, lateral dimensions in the plane XY of 2 mm*2 mm, and a thickness along the direction Z of 10 μm.

The formation of the stack 2 can be performed by a physical vapour deposition (PVD). This type of deposition makes it possible to simplify the integration of the magnet 20 to the reflective device 1.

The number N of bilayers of the stack 2 determines the total thickness of the magnet 20. The stack 2 can have a thickness of between 700 nm and 5 μm, preferably between 900 nm and 2 μm, and even more preferably equal to 1 μm. The length of the magnet in the plane XY can be around 5 mm. Its width in the plane XY can be greater than or equal to 200 μm, preferably strictly greater than 200 μm according to the example of bar-shaped sub-magnets 25.

The effective magnetic thickness of the magnet 20 is the sum of the thicknesses of all of the second ferromagnetic sub-layers 4. Indeed, the antiferromagnetic material has substantially compensated magnetic moments, and consequently, does not produce a magnetic field, or produces an extremely low magnetic field. These are mainly the magnetic moments present in the ferromagnetic material which contribute to the actual magnetisation of the magnet 20. The second sub-layer 4 has a thickness e₄ of between 2 nm and 40 nm, preferably, between 20 nm and 40 nm.

The effective magnetic thickness can be substantially between 350 nm and 2.5 μm, preferably between 450 nm and 1 μm, and even more preferably, can be substantially equal to 0.5 μm, according to the number of second ferromagnetic sub-layers 4.

The ferromagnetic material can be based on a soft magnetic material, having a high saturation magnetisation Mₛ, typically greater than 1000 emu/cm³. The ferromagnetic material can be, for example, based on an iron (Fe), cobalt (Co) and nickel (Ni) alloy. Preferably, the ferromagnetic material is CoFe-based.

The ferromagnetic material can be based on an alloy comprising manganese (Mn), for example of the NiMn, PdPtMn, FeMn type, or NiO- or Fe₂O₃-based. The antiferromagnetic material is preferably PtMn- or IrMn-based.

The composition of the CoFe ferromagnetic material makes it possible to control the saturation magnetisation Mₛ of the magnet 20. The ferromagnetic material can be richer in cobalt (Co) than in iron (Fe). This makes it possible to improve the exchange interaction between the first antiferromagnetic sublayers 3 and the second ferromagnetic sublayers 4, and consequently, to improve the resistance of the magnet 20 to magnetic shocks. However, this tends to decrease the saturation magnetisation Mₛ. For a 20% Fe and 80% Co composition, Mₛ can be around 1.8 T.

The ferromagnetic material can be richer in iron (Fe) than in cobalt (Co). This makes it possible to increase the saturation magnetisation Mₛ. However, this tends to decrease the exchange interaction between the first antiferromagnetic sublayers 3 and the second ferromagnetic sublayers 4. For a 65% Fe and 35% Co composition, Mₛ can be around 2.4 T.

The composition of the antiferromagnetic material is chosen so as to improve the exchange interaction between the antiferromagnetic and ferromagnetic sublayers. This composition can be, for example, 50%±5% platinum (Pt) and 50%±5% manganese (Mn), or 20%±5% iridium (Ir) and 80%±5% manganese (Mn).

For a PtMn-based stack 2, the heat treatment can be performed at a temperature of between 290° C. and 400° C., preferably around 320° C. For an IrMn-based stack 2, the heat treatment can be performed at a temperature of between 265° C. and 350° C., preferably around 280° C. The thermal annealing can be performed for a duration greater than or equal to 1 hour.

The stack 2 can be formed such that each second ferromagnetic sublayer 4 is located between two first antiferromagnetic sublayers 3, which makes it possible to improve the exchange interaction. This can be done by adding an additional antiferromagnetic sublayer on the N bilayers of the stack 2.

Each of the first antiferromagnetic sublayers 3 can have a thickness of between 2 nm and 50 nm, preferably around 20 nm for a PtMn-based antiferromagnetic material, and preferably around 8 nm for an IrMn-based antiferromagnetic material.

The stack 2 can comprise a preliminary layer, on which the magnetic bilayers are deposited. The preliminary sublayer can be tantalum (Ta)-based. This preliminary sublayer can have a thickness of around 5 nm.

The orientation of the magnetic field applied during the heat treatment is chosen according to the magnetisation M of the desired magnet 20. According to an example, and in particular, when the deposition of the stack is configured so as to form juxtaposed and bar-shaped sub-magnets 25, the magnetic field applied has a direction which forms a 45° angle with the directions X and Y. This makes it possible to obtain, at the end of the heat treatment, two perpendicular magnetisation directions. The magnetic field applied preferably has an intensity greater than or equal to 1 T. According to the example in which the direction of the magnetic field makes a 45° angle with the directions X and Y, the intensity of the magnetic field greater than or equal to 1 T is applied preferably during an increase in temperature of the thermal annealing, as well as during a constant temperature plateau. The intensity of the magnetic field is then decreased to a value of between 20 Oe (that is 1591.54 A/m) and 300 Oe (that is 23873.24 A/m) during a descent in annealing temperature. This enables the shape anisotropy to fix the magnetisations in the desired directions.

The stack 2 can further comprise an encapsulation layer which makes it possible to protect the magnetic bilayers. This encapsulation layer can comprise a tantalum (Ta)-based sublayer, having for example, a thickness of 5 nm, and a ruthenium (Ru)-based sublayer having, for example, a thickness of 8 nm.

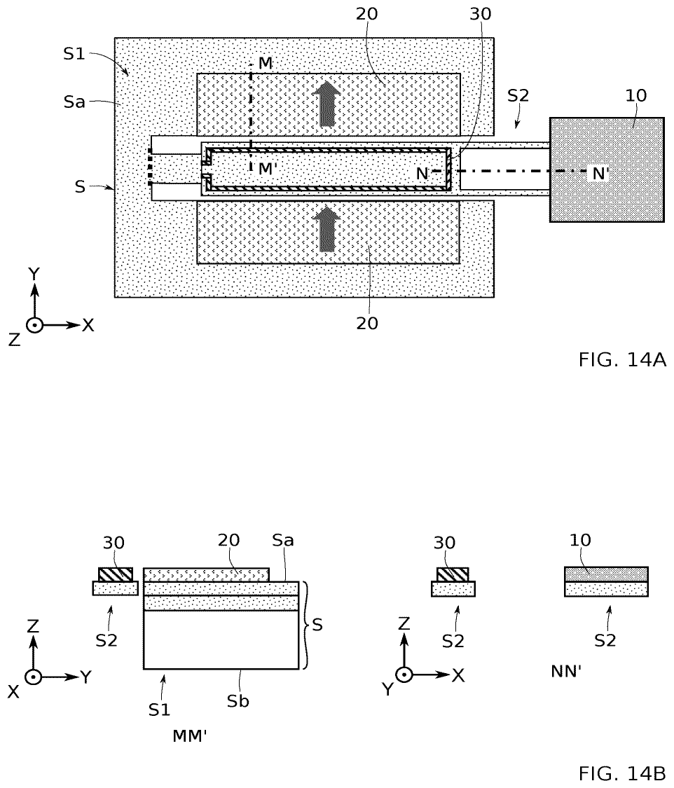

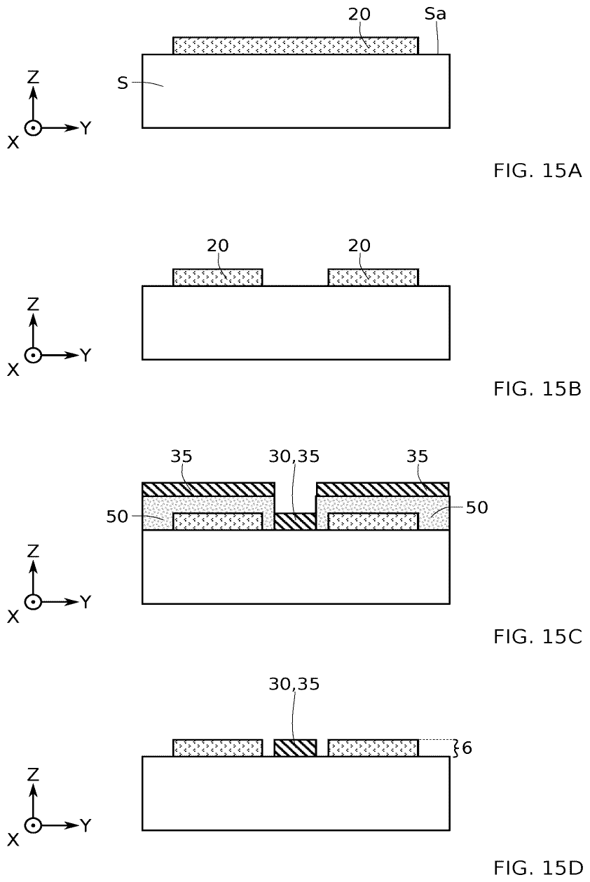

The following paragraphs of the present description, describe examples of manufacturing the actuator module 6 according to the first embodiment, in reference to FIGS. 15A-15D, 16A-16F and 17A-17I. A person skilled in the art will adapt these figures without difficulty to view the different steps of manufacturing the actuator module 6 according to the second embodiment.

A first step of manufacturing the actuator module 6, common to all the examples described below, illustrated in FIGS. 15A and 15B, can comprise the following substeps:
The deposition of the stack 2 on the substrate S, as illustrated in FIG. 15A;
The deposition of an oxide-based hard mask on the magnet (stack 2), not illustrated;
A formation by lithography of an opening through the hard mask, preferably by reactive ion etchings (RIE);
An etching of the stack 2 through the opening in the mask, so as to form two first distinct magnets 20 as illustrated in FIG. 15B, this etching is preferably performed by ion beam etching (IBE).
   The two magnets 20 formed are separated by a space exposing internal flanks of the two first magnets 20 and the upper face Sa of the substrate S. The oxide-based hard mask can be preserved on the magnets in order to protect them.
   As illustrated in FIG. 15C, following the formation of the separated magnets 20, according to a first example of an embodiment of the actuator module 6, a resin layer 50 is deposited on the two first magnets 20 so as to cover the surface and the internal flanks of the two first magnets 20 and to define a pattern intended for the formation of the at least one electric line 30 between the two first magnets 20. The electrically conductive material 35 is then deposited in the pattern defined in the preceding step, to form the at least one electric line 30. A removal of the resin layer 50 is performed after the deposition of the electrically conductive material 35.

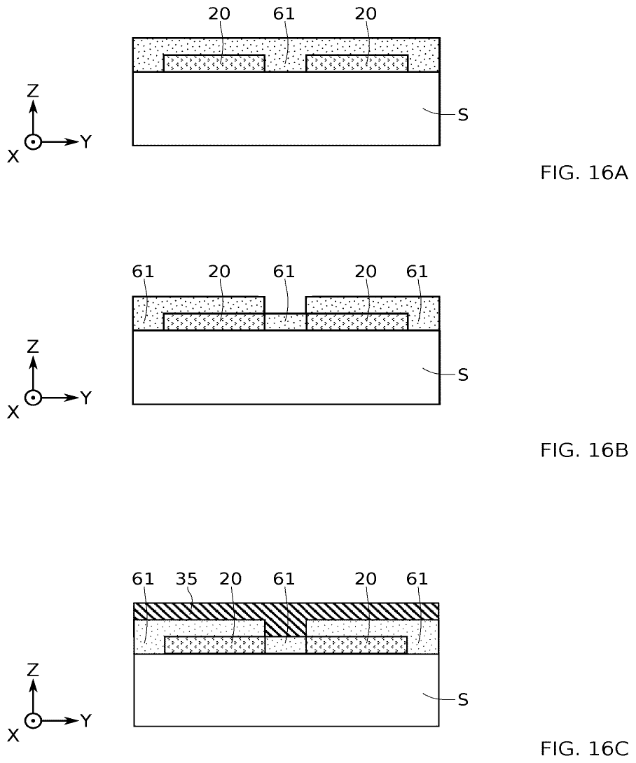

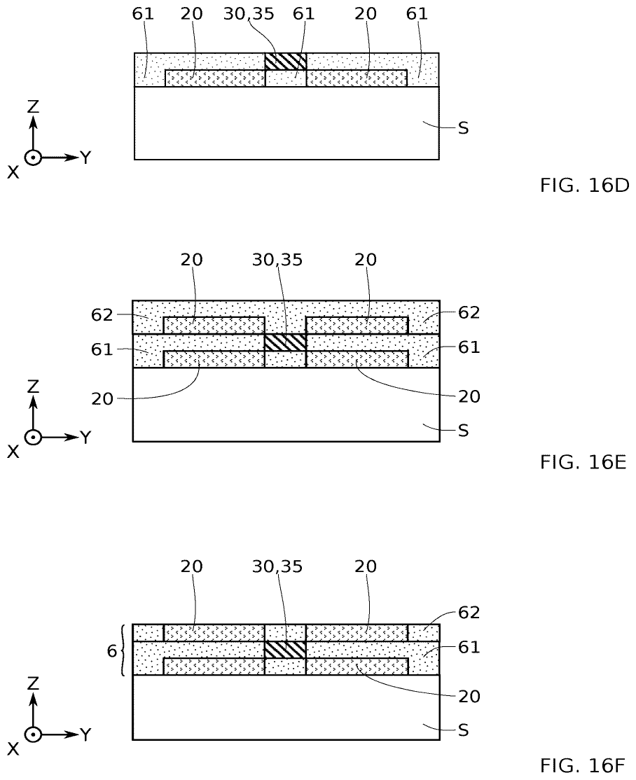

As illustrated in FIGS. 16A-16F, according to a second example of an embodiment of the actuator module 6, a first oxide layer 61 is deposited on the two first magnets 20 so as to cover the surface and the flanks of the two first magnets 20, and to fill at least partially, and preferably fully, the space between the two first magnets 20. A partial etching of the first oxide layer 61 is then performed in vertical alignment of the space between the two first magnets 20, substantially to the plane comprising the upper face of the two first magnets 20, in order to form a pattern intended for the formation of the at least one electric line 30. An electrically conductive material layer 35 is then deposited on the first oxide layer 61, in order to fill at least partially, and preferably fully, the pattern defined in the preceding step, to form the at least one electric line 30. The electrically conductive material layer 35 is then planarised up to substantially reaching the first oxide layer 61. Two distinct second magnets 20 can be formed above the first oxide layer 61, and in vertical alignment with the two first magnets 20. A second oxide layer 62 can be deposited so as to cover the surface and the flanks of the two second magnets 20, and to fill at least partially, and preferably fully, the space between the two second magnets 20. The second oxide layer 62 can be planarised so as to expose the upper face of the two second magnets 20. The stack of the magnets 20 makes it possible to increase the saturation magnetisation Mₛ which makes it possible to facilitate the actuation of the rotation of the mirror 10.

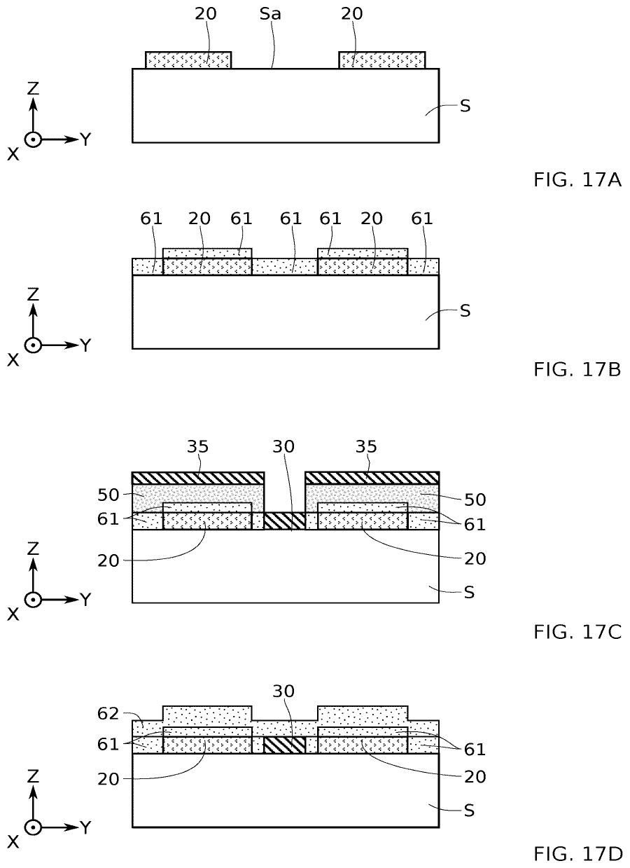

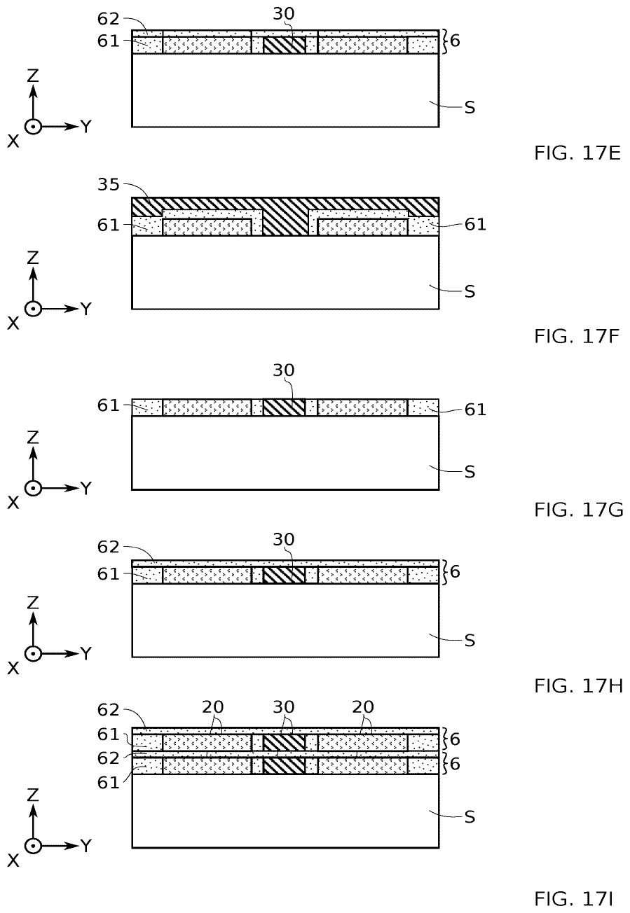

As illustrated in FIGS. 17A-17E, according to a third example of an embodiment of the actuator module 6, a first oxide layer 61 is deposited on the upper face Sa of the substrate S, so as to cover the surface and the flanks of the two first magnets 20, and to fill at least partially, and preferably fully, the space between the two first magnets 20. An etching of the first oxide layer 61 is then performed between the two first magnets 20 so as to expose the upper face Sa of the underlying substrate S, and preferably expose the internal flanks of the two first magnets 20. A resin layer 50 is then deposited on the first magnets 20, so as to define a pattern between the two first magnets 20 separated from the internal flanks of the two first magnets 20, intended for the formation of the electric line 30. The deposition of the resin layer 50 on the first magnets 20 can, for example, be configured so as to cover at least the internal flanks of the two first magnets 20. The electrically conductive material 35 is then deposited in the pattern defined in the preceding step, to form the electric line 30. The resin layer 50 is then removed, and a second oxide layer 62 is deposited so as to fill at least partially, and preferably fully, the space between the electric line 30 formed and the two first magnets 20. The second oxide layer 62 can be planarised without exposure of the surfaces of the magnets 20. A first actuator module 6 formed at the end of this example, can be reproduced by following the same steps described in reference to FIGS. 17A-17E, in order to form a second actuator module 6 superposed to the first, as illustrated in FIG. 17I.

More generally, it is understood that the actuator modules 6 can therefore be superposed in the reflective device 1. The superposition of the actuator modules 6, in particular of the magnets 20, makes it possible to increase the actual saturation magnetisation Mₛ, which makes it possible to facilitate the actuation of the rotation of the mirror 10.

According to another example, as illustrated in FIGS. 17F-17I, the first oxide layer 61 can be partially etched between the two first magnets 20 so as to expose at least partially the upper face Sa of the substrate S, without exposing the internal flanks of the two first magnets 20, and to define a pattern intended for the formation of the electric line 30. The electrically conductive material 35 is then deposited in the pattern defined in the preceding step, to form the electric line 30. The electrically conductive material layer 35 can be planarised, preferably without exposing the upper face of the two first magnets 20, and a second oxide layer 62 can be deposited, so as to cover the two first magnets 20 and the electric line 30. A first actuator module 6 formed at the end of this example, can be reproduced by following the same steps described in reference to FIGS. 17F-17H, in order to form a second actuator module 6 superposed to the first, as illustrated in FIG. 17I.

In view of the description above, it clearly appears that the proposed method offers a particularly effective solution for integrating at least one magnet 20 to a reflective device 1 by deposition of a stack 2. This solution is further advantageously compatible with standard microelectronic methods.

The invention is not limited to the embodiments described above and extends to all the embodiments covered by the invention. Different particular examples of manufacturing methods, as well as reflective device configurations have been described. Plenty of other variants of embodiments are possible, for example, by combining features described above, without departing from the scope of the invention. Furthermore, the features described relative to an aspect of the invention can be combined with another aspect of the invention.

1. A reflective device intended to reflect an incident light beam comprising:
a substrate comprising a first part, and a second part which is mobile relative to the first part about at least one axis of rotation,
a mirror disposed securely on the second part of the substrate, the mirror being configured to be pivoted about the at least one axis of rotation and so as to receive the incident light beam to form a reflected beam, and
an actuator module comprising at least one magnet and at least one electric line configured to be passed through by an electric current, the at least one electric line being based on an electrically conductive material, the actuator module being configured to rotate the second part of the substrate and of the mirror by a motor force generated by an interaction between the at least one magnet and the electric current passing through the at least one electric line,
wherein one from among the at least one magnet and the at least one electric line is disposed on the first part of the substrate, the other from among the at least one magnet and the at least one electric line is disposed on the second part of the substrate securely to the mirror, and the at least one magnet comprises a stack of at least one bilayer comprising a first sublayer based on an antiferromagnetic material and a second sublayer based on a ferromagnetic material, the stack being magnetised along at least one magnetisation direction.

2. The reflective device according to claim 1, wherein the at least one magnet and the at least one electric line are separated by a shortest distance between the at least one magnet and the at least one electric line, the distance being greater than or equal to 500 nm and less than or equal to 7 μm.

3. The reflective device according to claim 1, wherein the second sublayer based on a ferromagnetic material has a thickness of between 2 nm and 50 nm.

4. The reflective device according to claim 1, wherein the stack of the at least one magnet has a thickness of between 700 nm and 5 μm.

5. The reflective device according to claim 1, wherein the stack of the at least one magnet comprises N superposed bilayers, N being an integer of between 10 and 50.

6. The reflective device according to claim 1, wherein the actuator module is configured such that two motor forces are exerted on the second mobile part of the substrate, the forces being in opposite directions from one another:
the actuator module comprises at least two magnets, the at least one electric line being disposed on the second mobile part of the substrate securely to the mirror, the at least two magnets being respectively disposed on the first part on either side of the at least one electric line with respect to the at least one axis of rotation of the mirror, or
the actuator module comprises at least two electric lines, the at least one magnet being disposed on the second mobile part of the substrate securely to the mirror, the at least two electric lines being respectively disposed on the first part of the substrate on either side of the at least one magnet with respect to the at least one axis of rotation of the mirror.

7. The reflective device according to claim 1, wherein
the actuator module is configured such that two motor forces are exerted on the second mobile part of the substrate, the forces being in opposite directions from one another, the module comprising at least two magnets, the at least one electric line being disposed on the second mobile part of the substrate securely to the mirror, the at least two magnets being respectively disposed on the first part on either side of the at least one electric line with respect to the at least one axis of rotation of the mirror,
the second mobile part of the substrate has a recess around which the at least one electric line forms a loop, and
the reflective device further comprises a third magnet secured to the first part of the substrate and disposed in the recess.

8. The reflective device according to claim 1, wherein the mirror surmounts one from among the at least one magnet and the at least one electric line.

9. The reflective device according to claim 1, wherein the at least one magnet comprises a plurality of sub-magnets juxtaposed with one another, each sub-magnet being bar-shaped and comprising the stack of at least one bilayer.

10. The reflective device according to claim 9, wherein the sub-magnets have magnetisation directions which are distinct from one another.

11. A method for manufacturing the reflective device according to claim 1, comprising:
providing the substrate,
forming the actuator module on an upper face of the substrate, the forming comprising:
depositing, on the upper face of the substrate, of the stack of at least one bilayer comprising a first sublayer based on an antiferromagnetic material and a second sublayer based on a ferromagnetic material, superposed to the first sublayer,
heat treating the stack deposited under application of a magnetic field so as to magnetise the stack according to at least one magnetisation direction, and
depositing an electrically conductive material on the upper face of the substrate, so as to form the at least one electric line,
depositing the mirror on the upper face of the substrate, and
at least one etching of the substrate so as to form the first part and the second mobile part relative to the first part about at least one axis of rotation, the depositings and the etching being configured together, such that the mirror is deposited on the second part of the substrate, one from among the at least one magnet and the at least one electric line is disposed on the first part of the substrate, the other from among the at least one magnet and the at least one electric line is disposed on the second part of the substrate.

12. The method for manufacturing the reflective device according to claim 11, wherein the ferromagnetic material is based on CoFe, and the antiferromagnetic material is based on PtMn or IrMn.

13. The method for manufacturing the reflective device according to claim 11, wherein the heat treatment treating of the stack is performed at a temperature greater than or equal to 265° C., for a duration greater than or equal to 1 hour.

14. The method for manufacturing the reflective device according to claim 11, wherein an intensity of the magnetic field applied during at least some of the heat treating is greater than or equal to 1 T.

15. The method for manufacturing the reflective device according to claim 11, wherein forming the actuator module further comprises:
etching the stack deposited so as to form two distinct first magnets, separated by a space exposing internal flanks of the two first magnets and the upper face of the substrate.

16. The method for manufacturing the reflective device according to claim 15, wherein forming the actuator module, further comprises:
depositing a resin layer on the two first magnets so as to cover a surface and the internal flanks of the two first magnets and to define a pattern configured for the formation of the at least one electric line between the two first magnets,
depositing the electrically conductive material in the pattern defined in the preceding step, to form the at least one electric line, and
removing the resin layer after the deposition of the electrically conductive material.

17. The reflective device according to claim 2, wherein the distance is greater than or equal to 500 nm and less than or equal to 5 μm.

18. The reflective device according to claim 1, wherein the second sublayer based on a ferromagnetic material has a thickness of between 10 nm and 50 nm.

19. The reflective device according to claim 1, wherein the stack of the at least one magnet has a thickness of between 900 nm and 2 μm.
